(19) United States
(12) Patent Application Publication
(10) Pub. No.: US 2024/0309922 A1
(43) Pub. Date: Sep. 19, 2024

(54) BRAKE DISC FOR A DISC BRAKE

(71) Applicant: Plansee SE, Reutte (AT)

(72) Inventors: Walter Hammerle, Reutte (AT); Michael Eidenberger-Schober, Reutte (AT); Michael Mark, Reutte (AT); Peter Loidolt, Reutte (AT)

(21) Appl. No.: 18/264,968

(22) PCT Filed: Feb. 3, 2022
(86) PCT No.: PCT/AT2022/060032

§ 371 Date: Aug. 10, 2023

(30) Foreign Application Priority Data
Feb. 10, 2021 (AT) GM 50023/2021

(51) Int. Cl. F16D 65/12; B22F 3/12; C22C 27/04

(52) U.S. Cl. CPC F16D 65/125; B22F 3/12; C22C 27/04; B22F 2301/20; F16D 2200/0026

(57) ABSTRACT

A brake disc, also referred to as a rotor, for a disc brake has the function of interacting with a brake lining as a friction partner in the disc brake. The brake disc is formed at least in part of a material having a molybdenum content of ≥50 wt. %.

The present invention relates to a brake disk having the features of the preamble of claim 1.

Brake disks have the function of interacting with a brake lining as friction partner in a disk brake. A disk brake comprises, as friction partner, a brake disk (also referred to as rotor) and at least one brake lining which is pressed against the brake disk in order to generate friction.

Friction forces are typically transmitted as braking torque to a hub. A majority of the resultant heat is introduced into the brake disk and has to be removed therefrom. Use of a brake disk results in occurrence of considerable thermal and mechanical stresses.

Brake disks for disk brakes generally consist of steel or cast iron.

WO2012157680 (A1) describes, for example, a martensitic stainless steel for a brake disk for a bicycle.

The aim is to increase the thermal and/or mechanical durability of brake disks.

It is an object of the present invention to specify an improved brake disk.

The object is achieved by a brake disk having the features of claim 1. Preferred developments are set out in the dependent claims.

According to the invention, the brake disk consists at least partly of a material having a molybdenum content of ≥ (greater than or equal to) 50 wt. % (percent by weight). A brake disk for a disk brake typically comprises a friction section, a securing section for securing the brake disk to a hub or the like, and a carrier section for transmitting the forces between friction section and securing section. In general, a brake disk has distinct material cutouts. What is meant more particularly here by “distinct” is that more than 10% of the area is not filled with material.

The material having a molybdenum content of ≥50 wt. % is preferably metallic. The material having a molybdenum content of ≥50 wt. % may, for example, be a molybdenum-based alloy, or a composite material with molybdenum (for instance a copper-infiltrated molybdenum), or a composite material composed of different layers (for example a laminate or a composite with sprayed layers), or else pure molybdenum. In other words, at least sections of molybdenum or a molybdenum-based material are proposed for a brake disk. In the case of an alloy, the mixture consists of molybdenum with alloy elements at an atomic level, whereas, in the case of composite materials and material composites, there exists a composite of molybdenum with at least one further material at a macroscopic level.

The material preferably has a molybdenum content of ≥80 wt. %, further preferably ≥90 wt. %, especially preferably ≥95 wt. %. In other words, the material preferably consists predominantly of molybdenum. Owing to the commercial availability of semifinished products made of molybdenum or of a molybdenum-base alloy, creation from pure molybdenum or a molybdenum-base alloy may be particularly economically viable.

In general, and with preference, the material is produced by powder metallurgy. Production by powder metallurgy comprises providing and compacting metal powders, followed by sintering. A material produced by powder metallurgy has a sintered microstructure and can be recognized as such from microstructure images by the person skilled in the art. Features of a sintered microstructure, especially of the sintered microstructure of a molybdenum-base alloy, include a finer and more homogeneous grain structure compared to a cast microstructure. In general, the material is particularly chemically homogeneous.

In addition, especially in the case of refractory metals, a powder metallurgy route is more economically viable. One reason for this is that sintering proceeds well below a melting temperature.

In general, materials having a molybdenum content of ≥50 wt. % are used owing to their high-temperature properties and/or corrosion resistance and/or exceptional thermophysical properties.

The applicant has found that, surprisingly, molybdenum or molybdenum-based materials have very advantageous properties for use in a brake disk.

Properties of particular interest have been found to be those that follow, which are tabulated below with the associated advantages over steel or aluminum as reference materials. The table compares material indices of pure molybdenum with those of a martensitic stainless steel, values in each case at room temperature (RT). Where applicable in the table, for a direct comparison, the steel with materials number 1.4021 was used as a particular representative of steels for brake disks, especially for brake disks of bicycles.

| Properties of molybdenum/ | Advantages of molybdenum over |
|---|---|
| molybdenum-based materials | reference |
| High wear resistance | Longer lifetime and/or lower |
| | permissible material thickness |
| High thermal conductivity | Improved heat removal (thermal |
| (thermal conductivity of | conductivity of 1.4021: 30 W/mK) |
| molybdenum: 142 W/mK) | |
| Low specific heat capacity | Faster to reach temperature, |
| (heat capacity of molybdenum | favorable especially in the case of |
| 0.25 J/(g K) | wet operation (heat capacity of |
| | 1.4021: 0.46 J/g K) |
| Low thermal expansion of Mo | Lower deformation of the brake disk |
| (5.3*10⁻⁶ K⁻¹) | (steel: 10.5*10⁻⁶ K⁻¹) |
| High modulus of elasticity | Higher stiffness than steel (modulus |
| (modulus of elasticity of | of elasticity of 1.4021: 215 GPa) |
| molybdenum: 320 GPa) | |

In studies by the applicant, particularly favorable brake disks have been found to be those based on molybdenum in the case of partial braking (short brake pulse) and in wet operation. The applicant has attributed this to the comparatively low specific heat capacity [J/gK] of molybdenum: even a short brake pulse results in rapid heating of the brake disk and dries it rapidly, before the high thermal conductivity of molybdenum ensures effective removal of heat.

The low thermal expansion of molybdenum leads to lesser deformation and/or lower thermally induced stresses.

Favorable friction characteristics were also found in the case of brake disks made of molybdenum, in that a coefficient of friction is essentially constant over a wide temperature range. This leads to a smaller change in braking properties with temperature by comparison with steel.

Moreover, the high strength and high modulus of elasticity of molybdenum permit a particularly slim brake disk.

A brake disk, in terms of its spatial areas and the associated predominant functions, may typically be divided into:
a friction section which is in a friction pairing with a friction partner in a braking operation,
a securing section which is (generally) close to the middle for securing of the brake disk on a hub or the like,
a carrier section in between for transmission of the forces between the friction section and securing section.

The friction section refers to that geometric region of the brake disk where braking energy is introduced in operation. In general, the friction section is on an outer circumference of the brake disk. The braking energy is provided via friction, in that brake linings are pressed against the rotating brake disk. In particular, the friction section is circumferential, meaning that it forms a continuous disk ring.

It may be the case that the brake disk has a circumferential friction section consisting at least partly of a material having a molybdenum content of ≥50 wt. %.

The circumferential friction section is a region of the brake disk that can be fixed in terms of its radial extent and is intended for contact with at least one friction partner (typically a brake lining). Thus, in this variant, only that section of the brake disk which is in a friction pairing with a friction partner in a braking operation is formed from the material having a molybdenum content of ≥50 wt. %.

It may also be the case that the material with a molybdenum content of ≥50 wt. % is arranged in the form of inserts in the friction section.

The circumferential friction section may be cohesively bonded to the rest of the brake disk or take the form of a ring which is mechanically and/or cohesively bonded to a carrier section of the brake disk.

The material having a molybdenum content of ≥50 wt. % need not necessarily form an outer surface of the circumferential friction section.

However, the material having a molybdenum content of ≥50 wt. % preferably forms an outer surface of the circumferential friction section. This also includes variants made of the Mo-containing material with a coating. A coating of a different material for this application typically has a thickness of a few μm (thickness especially <20 μm).

In particular, the circumferential friction section preferably consists entirely of the material having a molybdenum content of ≥50 wt. %, apart from any coating.

As already stated, the material having a molybdenum content of ≥50 wt. %, which forms the circumferential friction section here, preferably has a molybdenum content of ≥80 wt. %, further preferably ≥90 wt. %, especially preferably ≥95 wt. %.

The circumferential friction section may be designed as a separate component which is bondable to the carrier section. For example, it is conceivable to manufacture solely the circumferential friction section from a material having a molybdenum content of ≥50 wt. % and to bond it to a favorable and/or lightweight carrier section, for example made of steel or aluminum.

In one variant, the complete brake disk is formed from the material having a molybdenum content of ≥50 wt. %. This is the simplest solution for manufacturing purposes. In this development too, it is preferably the case that the material has a molybdenum content of ≥80 wt. %, further preferably of ≥90 wt. %, especially preferably of ≥95 wt. %. In other words, it is preferably the case that the brake disk is manufactured from molybdenum or a molybdenum-base alloy.

It is preferably the case that the entire brake disk is in one-piece form, meaning that there is preferably no physical separation of the sections mentioned. This enables particularly simple manufacture, for example by cutting or punching. Useful techniques for cutting of molybdenum-base alloys have been found to be, for example, laser cutting and waterjet cutting. This manufacturing route makes use of a semifinished product, especially sheet metal, as starting material. The semifinished product has preferably been produced by forming, especially by rolling, of a blank produced by powder metallurgy.

A further option is creation via pressing and sintering (p/s). This dispenses with the step of producing a semifinished product. Instead, in the route via pressing and sintering, the later shape of the component is defined at the early stage of the pressing operation and then sintered. Using the example of a brake disk, this can be produced in near net shape, for example, by uniaxial pressing and sintering. This may optionally be followed by a material-removing processing operation and/or a calibration.

It may be the case that the material having a molybdenum content of ≥50 wt. % that forms at least part of the brake disk takes the form of a composite material or of a material composite.

In the case of a composite material, a matrix is present as the first phase, into which a second phase (for example copper) is embedded. The matrix here may preferably be formed by molybdenum, infiltrated by a second metal.

In a material composite, there are typically discrete layers of different materials. One example of a material composite is a laminate composed of laminas of molybdenum and copper. There may of course be mixed forms. The literature too does not always distinguish sharply between composite materials and material composites.

By virtue of the material taking the form of a composite material or of a material composite, the favorable properties of molybdenum may advantageously be combined with properties of other materials.

Emphasis should be given here to the possibility of enhanced heat removal by combination with copper (thermal conductivity at room temperature: 398 W/mK) or aluminum (thermal conductivity at room temperature: 234 W/mK).

The composite material may be formed, for example, by a porous molybdenum body impregnated by another material, typically by copper.

The material composite may also be formed by a layer assembly composed of laminas of molybdenum and other material. One representative of this type of material composites is, for instance, a laminate composed of molybdenum laminas and copper laminas.

For the brake disk, owing to the low density and high thermal conductivity of aluminum, a material composite with aluminum may be of particular interest. Aluminum would then preferably form a lamina in the core of the material composite, while molybdenum forms outer laminas.

It may be the case that the material having a molybdenum content of ≥50 wt. % that forms at least part of the brake disk takes the form of a sprayed layer.

It is conceivable here, for example, that molybdenum is applied as sprayed layer to a carrier body. The carrier body may consist, for example, of steel or aluminum. The sprayed layer of molybdenum or a mixture with molybdenum may preferably be formed in that region of the brake disk which is intended for contacting with a friction partner. The sprayed layer may be formed, for example, via flame spraying or cold gas spraying.

In one development, there is a friction layer and/or a carrier body made of a different material in the form of a sprayed layer on molybdenum, for example on a molybdenum sheet.

It has been found to be particularly advantageous when the material with a molybdenum content of ≥50 wt. % is formed by a molybdenum alloy having a molybdenum content of ≥99.93 wt. %, a boron content of ≥3 ppmw (ppm by weight) and a carbon content of ≥3 ppmw. Further preferably, the total proportion of carbon and boron is within a range between ≥15 ppmw and ≤50 ppmw. With this composition, particularly balanced mechanical properties were achieved.

This microdoped molybdenum alloy is notable for exceptional ductility and damage tolerance, and has good weldability. The aforementioned creation via pressing and sintering (p/s) is of particular interest for this molybdenum alloy since, even in the press-sintered state (i.e. without forming), it has excellent strength and ductility values.

Unless stated otherwise, in the case of figures that do not add up to 100%, the difference is formed by customary impurities.

For all developments relating to the molybdenum-based material, the brake disk may consist partly or else entirely of the material in question.

The brake disk is preferably designed for a motorized or unmotorized vehicle, especially for a two- or three-wheel vehicle. Further preferably, the brake disk is designed as a brake disk for a two-wheel vehicle, especially for a bicycle.

Especially in the case of brake disks of bicycles, the advantageous properties of molybdenum-base materials are manifested to a particular degree. In particular, the trend toward E-bikes (electrically-driven or at least electrically-assisted bicycles) has led to a need for robust brake disks, since the masses in motion and speeds are greater here than in the case of purely muscle-driven bicycles. These factors are also applicable, for example, in the case of cargo bicycles and bicycle trailers.

It is also the case that braking characteristics with braking pauses for cooling of the brake disks, which are favorable for disk brakes, are not always assured.

Brake disks of the invention, in this connection, are particularly advantageous owing to elevated thermal durability and favorable braking properties.

For this application, in particular, cargo bicycles, E-bikes (bicycles with electric motor assistance, even without pedaling) and pedelecs (bicycles with electric motor assistance when pedaling) are also considered to be bicycles, even if these may have more than two wheels and/or are not considered to be bicycles according to road traffic rules.

Brake disks for two-wheel vehicles, especially bicycles, are frequently manufactured from sheet metal material, whereas brake disks for cars or trucks generally consist of cast material.

The creation of brake disks from sheet metal material is an option for two-wheel vehicles, especially bicycles, since the brake disks can be obtained inexpensively from sheet material by cutting or punching. For mopeds and lighter three-wheel vehicles as well, production from sheet metal is possible. Typical dimensions of brake disks for bicycles are, for example:
diameters of brake disks for bicycles are typically between 140 mm and 180 mm; for downhill wheels, diameters of 203 mm and higher are customary.

Material thicknesses are typically at least 1.5 mm to 2.5 mm.

Below 1.5 mm, conventional brake disks do not have sufficient stiffness. The use of molybdenum may be advantageous here owing to its high modulus of elasticity compared to steel.

Material thicknesses of more than 2.5 mm are unusual owing to the high mass. However, a low weight of the brake disks is less important in the downhill sector. Brake disks of thickness 2.5 mm are quite commonly used here, and are particularly robust.

Frequently, the brake disks have holes and/or cutouts. The holes and/or cutouts serve to improve a cooling effect and to reduce weight.

In addition, brake disks generally have a securing section via which the braking torque generated can be transmitted to a hub. The securing section may be implemented, for example, as a polygon receiver or via screw holes. Add-on components may also be provided, by which the brake disk is secured on the hub.

Protection is also being sought for a disk brake with a brake disk of the invention. A disk brake is composed essentially of brake disk, brake caliper and brake linings. The brake caliper serves to accommodate and deliver the brake linings to the brake disk. The actuation may be hydraulic or mechanical. The brake disk and the brake linings are the friction partners in the disk brake system.

Protection is also being sought for the use of a brake disk of the invention in a disk brake, especially in a disk brake of a two-wheel vehicle, especially of a bicycle.

Also disclosed is a disk brake, wherein at least one of the friction partners consists at least partly of a material having a molybdenum content of ≥50 wt. %. This expresses the possibility that even solely the brake linings may consist of a material having a molybdenum content of ≥50 wt. %. Several of the benefits of molybdenum, especially wear resistance, are also beneficial for use in a brake lining.

In a further variant, a brake lining that may also contain less than 50 wt. % of molybdenum is proposed. Even in the case of lower contents of molybdenum, for example ≥10 wt. %, preferably ≥20 wt. %, further preferably ≥30 wt. %, molybdenum ensures good wear resistance.

In an arrangement with a brake lining comprising molybdenum, the brake disk could be of conventional physical composition, for example consisting of steel.

Protection is also being sought for a method of producing a brake disk. The method comprises the steps of:
providing a powder mixture with a molybdenum content of ≥50 wt. % and
   i) pressing and sintering the powder mixture to give a sintered body, forming the sintered body to a semifinished product, and cutting out the brake disk,
   or
   ii) pressing the powder mixture to near net shape, followed by sintering and optional processing to create the brake disk.

In the first variant (i), a semifinished product is thus first produced via a powder metallurgy route. For production of a brake disk, a sintered body would typically be rolled to a sheet and brake disks would be cut out of it. If necessary, the brake disk may be reworked, for example ground.

In variant (ii), the brake disk is produced in near net shape via a powder metallurgy route. There is no production here of a semifinished product.

Both variants have the described advantages of the powder metallurgy route. The first variant (i) is advantageous in terms of flexibility, for instance with regard to size. The mechanical properties are generally also more favorable than of p/s material.

Also disclosed is the production of a brake lining. The method comprises the steps of:
providing a powder mixture with a molybdenum content of ≥10 wt. %
pressing and sintering the powder mixture to give the brake lining.

The powder mixture preferably contains ≥20 wt. % of molybdenum, further preferably ≥30 wt. % of molybdenum, especially ≥40 wt. % and further ≥50 wt. % of molybdenum.

As well as molybdenum, the powder mixture includes organic and/or inorganic friction media. Graphite may typically be present. The molybdenum ensures good wear resistance.

### Test Results

Summarized hereinafter are test results on brake disks of the invention by measurements on a friction testbed.

In the experimental setup, geometrically identical brake disks made of steel and those made of molybdenum were subjected to different braking energies, and the braking effects were compared. For this purpose, the brake disks were mounted flat on a steel carrier body, which was driven by an instrumented milling spindle.

The reference used was a “Centerline” steel brake disk from SRAM with a diameter of 160 mm. The molybdenum brake disk used was a geometrically identical brake disk made of molybdenum sheet material. The material thickness was in each case 1.8 mm.

The brake disks were subjected on one side via a brake lining to a normal force of 500 N (newtons). For the experiments, organically bound “Elixir XX Organic Compound” brake linings from SRAM were used.

A torque detector on the milling spindle was used to measure the resulting braking torque. The braking energies were varied via the speed. In the tests, the brake disks, at a speed of 240 rpm (revolutions per minute) to 1000 rpm, were subjected on one side to a normal force of 500 N. A single braking cycle lasted for 10 seconds, of which a stationary phase of constant braking force was maintained for five seconds in each case.

A test series comprised 100 braking cycles in each case. Overall, there were more than 1000 braking cycles on the respective brake disks made of steel and molybdenum.

It was found here that the molybdenum brake disks have much lower scatter of the braking torques under the same normal forces. In other words, the braking torques generated in the case of molybdenum brake disks are within a significantly narrower band than in the case of brake disks made of steel. For a user, this property can be experienced as a more uniform and softer braking action. The low scatter was observed both within a single braking operation and in the assessment of the average of the steady-state range over multiple braking cycles. The steady-state range of a braking operation characterizes a phase of constant braking force, as elucidated in more detail in the description of the figures. The low scatter in respect of a single braking operation means that a given actuation force in the case of molybdenum brake disks leads to a braking torque within a narrow band, which braking torque also fluctuates only slightly during braking. The braking action within a single braking operation is thus particularly uniform.

The low scatter of average braking torques in the assessment over multiple braking cycles means a predictable and accurately repeatable braking action.

Moreover, it has been found that molybdenum brake disks tend to give higher braking torques at high braking energies (tests with 1000 rpm) and consequently high temperatures than in the cold state. This property may favorably counteract fading (decline in braking action in the case of sustained braking).

As well as the tests on a friction testbed, practical tests were conducted with molybdenum brake disks on mountain bikes. In the course of the test runs, about vertical meters of downhill runs were performed.

Subjective experience with respect to steel brake disks as reference was recorded by the test cyclists in a comparison matrix. The following findings were made:

| | Assessment of molybdenum brake |
|---|---|
| Criterion | disk versus steel brake disk |
| Braking action in sustained braking | better |
| (high brake disk temperature) | |
| Braking action in the wet | better |
| Fading (decline in braking action in | better (less) |
| the case of sustained braking) | |
| Squeal | better (less) |
| Wear (visual assessment) | better (less) |

After the test runs, no wear could be detected on the molybdenum brake disks. By contrast, wear was detected on the steel disks.

Further advantages and benefits of the invention are apparent from the description of working examples that follows, with reference to the appended figures.

The figures show:

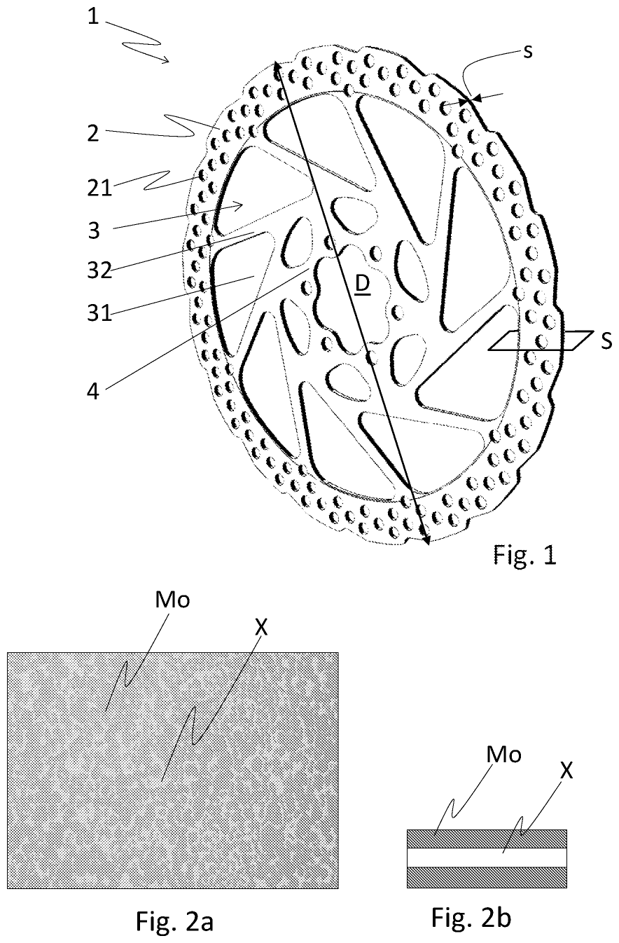

FIG. 1: a brake disk in a working example

FIG. 2a, 2b: schematic cross sections of further working examples

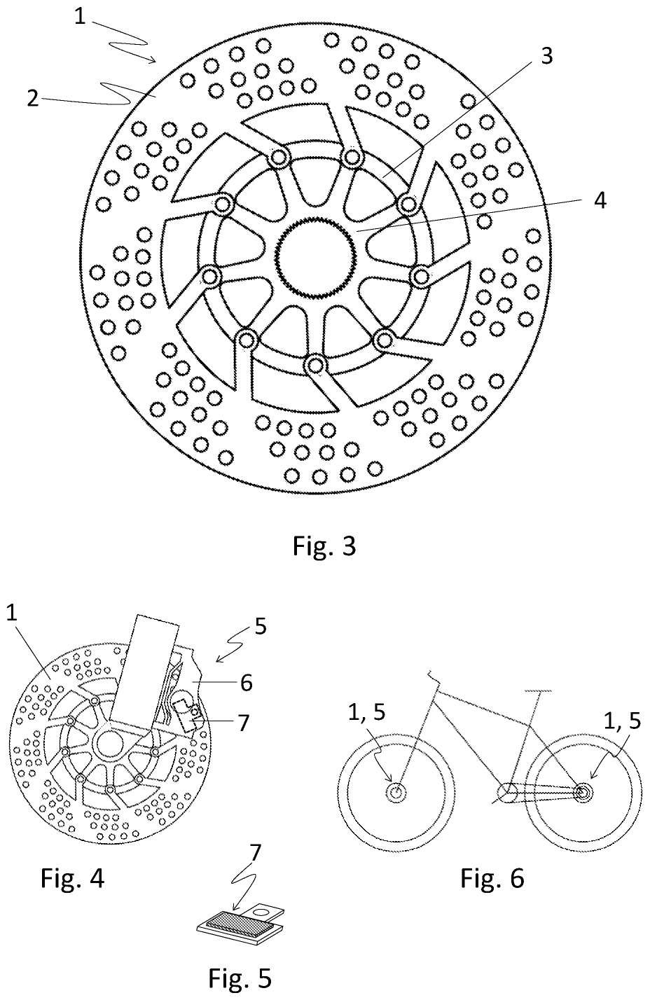

FIG. 3 a working example of an assembled brake disk

FIG. 4 a schematic diagram of a disk brake

FIG. 5 a schematic diagram of a brake lining

FIG. 6 a vehicle with a disk brake

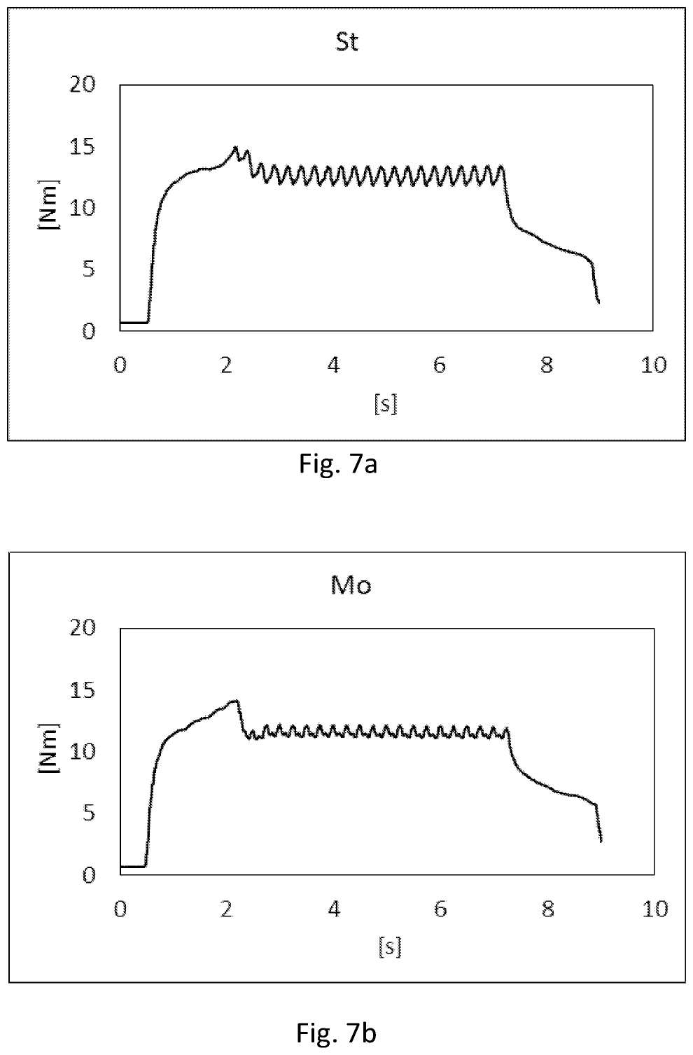

FIG. 7a, 7b a diagram of individual braking operations

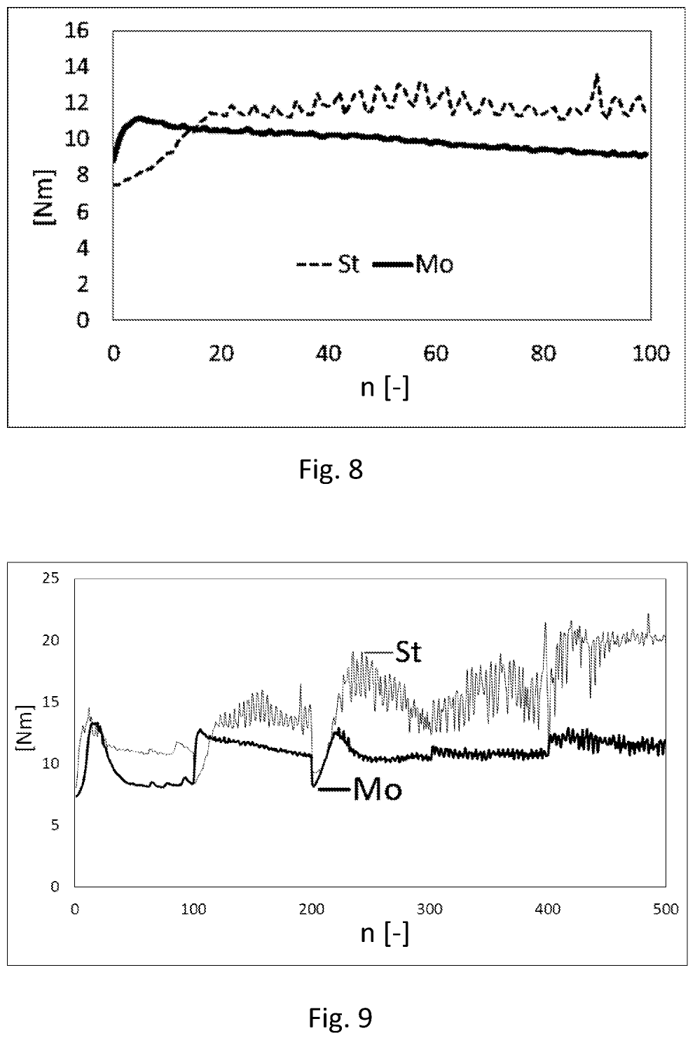

FIG. 8 a diagram of a series of 100 brake tests

FIG. 9 a diagram of a series of 500 brake tests

FIG. 1 shows a perspective view of a brake disk 1 in a working example. What is shown is a typical brake disk for disk brakes on bicycles. This type of brake disk features a slim design. A material thickness—s—is typically between 1.5 mm and 2.5 mm. A diameter—D—is typically between 140 mm and 210 mm.

The brake disk 1 has a circumferential friction section 2, which is in a friction pairing in a braking operation. Frequently, the friction section 2 has holes 21 for improved removal of heat. In general, a brake disk 1 has distinct material cutouts.

By means of a securing section 4, the brake disk 1 can be secured to a hub or the like for transmission of a braking torque. The securing section 4 is configured here as a 6-hole receiver.

There is a carrier section 3 between securing section 4 and friction section 2. Frequently, the carrier section 3 is not filled with material, but has distinct material cutouts 31, such that the carrier section 3 consists essentially of arms 32.

Dimensions of the arms 32 follow mechanical requirements. It is also possible for a heat budget of the brake disk 1 to influence the configuration of the carrier section 3.

Friction section 2, carrier section 3 and securing section 4 are not physically separated here. Instead, in the present working example, the brake disk 1 consists of one piece of a material having a molybdenum content of ≥50 wt. %. Production can especially be effected via laser cutting of sheet metal material.

As an alternative to the one-piece execution, friction section 2, carrier section 3 and securing section 4 may be manufactured separately and bonded to one another.

FIGS. 2a and 2b show, in schematic form and by way of example, cross sections of possible further forms of a material having a molybdenum content of ≥50 wt. %, of which the inventive brake disk 1 consists at least partly. The cross sections may be taken, for example, from a section in a cutting plane—S—from FIG. 1.

FIG. 2a shows a composite material composed of a framework of molybdenum (“Mo”) and a second material (“X”), which second material infiltrates the molybdenum framework.

Using the example of copper as second material, it is possible to achieve a particularly high thermal conductivity coupled with good mechanical indices. One example is a composite material with up to 30 percent by weight of copper. This composite combines the high thermal conductivity of copper and the low thermal expansion of molybdenum.

Using the example of aluminum as second material, it is possible to achieve high thermal conductivity coupled with very good mechanical indices and low weight.

FIG. 2b shows a schematic of a further alternative form of a material for an inventive brake disk 1. The material with a molybdenum content of ≥50 wt. % is present here as composite material of layers of molybdenum with at least one second material (“X”). For example, it may be the case that the laminas that form one surface of a brake disk 1 consist of molybdenum with a copper core laminated thereto.

Using the example of aluminum as second material, it is possible to achieve a high thermal conductivity coupled with very good mechanical indices and low weight.

There may also certainly be several layers and/or different material combinations. In particular, it is also conceivable to coat a carrier material, for example steel, with molybdenum. In particular, molybdenum may take the form of a layer applied by thermal spraying or one applied via cold gas spraying.

FIGS. 2a and 2b thus illustrate, by way of example and merely by way of extracts, possible forms of the molybdenum-based material.

It is conceivable to create the entire brake disk 1 from molybdenum-based composite materials or from material composites comprising molybdenum. However, it may be more economically viable to create merely the friction section 2 from a molybdenum-based composite material or material composite.

It is certainly the simplest case that the molybdenum-based material consists of pure molybdenum or of a molybdenum alloy.

FIG. 3 shows a brake disk 1 in a further working example. The circumferential friction section 2 therein is designed as a separate component connected to the carrier section 3. What is not shown here, but is additionally conceivable, is a physically separate design and subsequent bonding of carrier section 3 and securing section 4.

The circumferential friction section 2 is preferably formed from a molybdenum-based material. Carrier section 3 and securing section 4 may consist, for example, of steel.

The bonding of friction section 2 and carrier section 3 is implemented here via rivets as bonding means. Alternatively or additionally, other bonds or bonding techniques such as form-fitting, welding, soldering, adhesive bonding etc. are also conceivable.

The design shown here with a separately executed friction section 2 is of particular interest when the friction section 2 consists, for example, of a molybdenum-based composite material or material composite. In such a case, it is then possible for carrier section 3 and securing section 4 to be designed essentially with regard to mechanical criteria, while the friction section 2 may be designed predominantly with regard to its friction properties and/or heat management. In other words, this design enables decoupling of the design criteria of friction section 2, carrier section 3 and securing section 4.

It is also possible in a particularly simple manner by the design to achieve different material thicknesses in friction section 2, carrier section 3 and securing section 4.

It is certainly also conceivable to form a brake disk 1 according to the principle of construction detailed here even completely from a molybdenum-based material.

FIG. 4 shows a schematic of a disk brake 5 for a bicycle. The disk brake 5 comprises a brake disk 1, a brake caliper 6 and brake linings 7.

On actuation of the disk brake 5, the brake linings 7 are pressed against the brake disk 1 and create a braking effect by friction.

FIG. 5 shows a schematic of a brake lining 7. The brake lining 7 refers here to the actual friction lining fixed on a carrier plate.

For brake disks 1 made of a material having a molybdenum content of

≥50 wt. %, it is possible to use conventional, commercially available brake linings 7.

In a further aspect of the disclosure, it may be the case that brake linings 7 consist of a material having a molybdenum content of ≥10 wt. %. It is preferably the case that the material has a molybdenum content of ≥20 wt. %, further preferably of ≥30 wt. %, especially preferably of ≥40 wt. % and further ≥50 wt. %. Benefits of molybdenum are also beneficial for use in a brake lining, especially the increase in wear resistance.

In such an arrangement, the brake disk could be in conventional physical form, for example consist of steel.

It is certainly possible, in the case of brake linings 7 made of a molybdenum-base material, for the brake disk 1 also to be formed from a molybdenum-base material.

FIG. 6 shows a schematic of a vehicle, in the present example a bicycle, equipped with disk brakes 5 having inventive brake disks 1. The inventive brake disks 1 are particularly suitable for two-wheel vehicles, especially for bicycles.

FIGS. 7a and 7b show diagrams of individual braking operations according to the test setup described further up.

An individual braking operation is divided in each case into a phase of about 2.5 seconds for buildup of a braking force, followed by a stationary phase of constant braking force of around five seconds. After about 7.5 seconds, the braking force is released again. For later discussion of steady-state braking characteristics, only the steady-state region between 2.5 seconds and 7.5 seconds of an individual braking operation is considered, and values from this range are used for averaging.

FIG. 7a shows the progression of the braking torque in [Nm] (newton meters) on the ordinate against time in seconds [s] for a braking operation on a steel brake disk (“St”). FIG. 7b, analogously, shows a braking operation on a molybdenum brake disk (“Mo”). The comparison of the two curves shows that the fluctuation in braking torque in the case of the steel brake disk is greater than in the case of the molybdenum brake disk. In the case of the molybdenum brake disk, a scatter of the braking torque in the steady-state region in a test selected as example was about 0.3 Nm about a mean of 11.6 Nm. In the case of steel, in a comparable data range, braking torque scatter in the steady-state region was around 0.5 Nm about a mean of 12.6 Nm. In practice, this means gentler braking characteristics within a braking operation with the molybdenum brake disk.

The mean braking torque on steel here is somewhat higher than in the case of molybdenum. One reason for this could be that the brake linings used are optimized for pairing with steel.

FIG. 8 shows a diagram of mean braking torque values of above-addressed steady-state regions of individual braking operations. Plotted in the diagram are mean braking torque values on the ordinate in [Nm] for the molybdenum brake disk (“Mo”-thick line) and the steel brake disk (“St”-thin dashed-and-dotted line) against the number—n—of braking cycles on the abscissa. A number—n—is dimensionless, i.e. [-]. 100 braking cycles were effected, and the plot corresponds to the chronological sequence of the individual braking operations.

What is striking is the significant scatter in the steady-state braking torques on the steel brake disk compared to a smooth progression with low scatter on the molybdenum brake disk. In practice, this means particularly uniform and repeatable braking characteristics with the molybdenum brake disk.

Also observed is a faster rise in the average braking torque in the case of molybdenum to a plateau after about three to five braking cycles, whereas, in the case of steel, a plateau was reached only after about 20 braking cycles. Without committing to any physical theory, the faster rise in the case of molybdenum could be attributable to the lower heat capacity and hence faster heating thereof. In practice, this means rapid attainment of an operating temperature with essentially the same friction characteristics.

FIG. 9 shows a summary of five test series, each of 100 braking cycles. What are again shown are the averaged braking torques from the steady-state regions of the individual braking operations. The braking torques are plotted on the ordinate in [Nm] against the number—n—[-] of braking cycles on the abscissa. The results were plotted in their chronological sequence. The results of the test series were added together for the diagram.

It can be seen that, in the case of the molybdenum brake disk (“Mo”—thick line), the overall impression from 500 braking operations is a braking torque of very good reproducibility. The variances within each of the five test series are smaller than in the case of the steel brake disk (“St”—thin line).

In addition, the scatter of the braking torque between the test series is smaller for molybdenum than for steel.

1-14. (canceled)

15. A brake disk for a disk brake, the brake disk comprising:
at least partly of a material having a molybdenum content of ≥50 wt. %.

16. The brake disk according to claim 15, further comprising a circumferential friction section, wherein said circumferential friction section containing at least partly of a material having a molybdenum content of ≥50 wt. %.

17. The brake disk according to claim 15, wherein said material with said molybdenum content of ≥50 wt. % takes a form of a composite material or of a material composite.

18. The brake disk according to claim 15, wherein said material with said molybdenum content of ≥50 wt. % at least partly takes a form of a coating.

19. The brake disk according to claim 15, wherein the brake disk is formed entirely from said material having said molybdenum content of ≥50 wt. %.

20. The brake disk according to claim 15, wherein said material having said molybdenum content of ≥80 wt. %.

21. The brake disk according to claim 15, wherein said material having said molybdenum content of ≥95 wt. %.

22. The brake disk according to claim 15, wherein said material having said molybdenum content of ≥50 wt. % is formed by a molybdenum alloy having a molybdenum content of ≥99.93 wt. %, a boron content of ≥3 ppmw and a carbon content of ≥3 ppmw.

23. The brake disk according to claim 15, wherein the brake disk has been produced by powder metallurgy.

24. The brake disk according to claim 23, wherein the brake disk has been produced by pressing and sintering.

25. A method of using a brake disk, which comprises the steps of:
providing a bicycle; and
installing the brake disk according to claim 15 on the bicycle.

26. A brake disk, comprising:
at least one brake caliper;
at least one brake lining; and
a brake disk containing at least partly of a material having a molybdenum content of ≥50 wt. %.

27. A disk brake, comprising:
at least one brake caliper;
a brake disk; and
a brake lining containing at least partly of a material having a molybdenum content of ≥10 wt. %.

28. A method of producing a brake disk, which comprises the steps of:
providing a powder mixture having a molybdenum content of ≥50 wt. %;
performing either of:
i) pressing and sintering the powder mixture to give a sintered body, forming the sintered body to give a semifinished product, and cutting out the brake disk; or
ii) pressing the powder mixture to near a net shape, followed by sintering.

29. The method according to claim 28, which further comprises additionally performing step ii) by processing the net shape to create the brake disk.
